(19) United States
(12) Patent Application Publication
(10) Pub. No.: US 2007/0056147 A1
(43) Pub. Date: Mar. 15, 2007

(54) Hook assembly

(76) Inventor: Richard J. Tracy, Elgin, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/437,555

(22) Filed: May 19, 2006

Related U.S. Application Data
(60) Provisional application No. 60/716,849, filed on Sep. 14, 2005.

(51) Int. Cl. F16B 45/00

(52) U.S. Cl. 24/265 H

(57) ABSTRACT

A hook assembly configured to securely connect a strap to a device includes first and second hook members, first and second covers, and a resilient sleeve. The first hook member is configured to pivot with respect to the second hook member into an open position. The first and second covers encase at least portions of the first and second hook members, respectively. The resilient sleeve secures the first hook member to the second hook member and exerts a constant force into the hook members to maintain them in a closed position.

### RELATED APPLICATIONS

This application relates to and claims priority benefits from U.S. Provisional Patent Application 60/716,849 entitled “Hook Device,” filed Sep. 14, 2005, which is hereby incorporated by reference in its entirety.

### FIELD OF THE INVENTION

Embodiments of the present invention generally relate to hook assemblies, and more particularly to hook assemblies configured for use with slings, straps, webbing, ropes, or the like.

### BACKGROUND OF THE INVENTION

Various devices include a strap, sling, webbing, rope, or the like that is configured to allow users to easily and comfortably carry or wear the devices. For example, a large weapon, such as a shotgun or a semi-automatic assault rifle, may include a lanyard, strap or sling operatively connected to the weapon that allows a soldier, hunter, police office or the like to carry the weapon over a shoulder.

When field operatives or law enforcement personnel are operating in tactical environments, their weapons need to “at-the-ready” at all times. As such, weapon slings have been used to allow for convenient carrying of the weapon at an easily accessible position.

Typically, slings are secured to devices, such as weapons, by hook devices. In a tactical encounter, a sling failure may have negative and even disastrous results. When a sling of a weapon fails, the failure is usually attributed to the failure of the hook devices, and not the strap or webbing. For example, a hook device may fail mechanically, such as a portion of the hook snapping off or a spring loaded gate malfunctioning. Also, normal wear and tear may adversely affect the hook device, particularly if the hook device includes a spring-loaded gate. In any event, any type of hook device failure may result in the loss of the attached weapon. At a minimum, if the strap device breaks or otherwise malfunctions, the weapon may be difficult to transport.

Moreover, many hook devices are of all metal construction. Such metal hook devices may rattle against the weapon, thereby producing unwanted noise in a tactical environment. Further, a metal hook produces an infrared signature that is apparent when viewed through night vision devices.

Thus, a need exists for a more durable and reliable hook assembly. Further, a need exists for a hook assembly that is not susceptible to rattling against a device, or producing a noticeable infrared signature.

### SUMMARY OF THE INVENTION

Certain embodiments of the present invention provide a hook assembly configured to securely connect a strap to a device. The hook assembly may include first and second hook members, first and second covers, and a resilient sleeve.

Each hook member may be formed of metal and include a strap-securing base integrally formed with an intermediate engagement member or area, which is in turn integrally formed with a hook. At least a portion of the intermediate engagement member of one hook member is pivotally biased into at least a portion of the intermediate engagement member of the other hook member at a pivoting interface. The first hook member is configured to pivot into an open position with respect to the second member about the pivoting interface.

The first cover encases a least a portion of the first hook member, and may be formed of an infrared reflective material. Similarly, the second cover encases at least a portion of the second hook member, and also may be formed of the infrared reflective material.

The resilient sleeve may be overmolded around at least portions of the strap-securing bases, thereby securing the first hook member to the second hook member. The resilient sleeve acts to squeeze the first and second hook members together in a closed position by exerting a constant inwardly directed force into the strap-securing bases.

### BRIEF DESCRIPTION OF SEVERAL VIEWS OF THE DRAWINGS

FIG. 1 illustrates a front perspective view of a hook member according to an embodiment of the present invention.

FIG. 2 illustrates a front perspective view of a hook member according to an embodiment of the present invention.

FIG. 3 illustrates a front perspective view of an over-molded hook member according to an embodiment of the present invention.

FIG. 4 illustrates a front perspective view of an over-molded hook member according to an embodiment of the present invention.

FIG. 5 illustrates a front perspective view of a hook assembly with an exposed joint gap according to an embodiment of the present invention.

FIG. 6 illustrates an isometric cross-sectional view of a hook assembly through line 6-6 of FIG. 5 according to an embodiment of the present invention.

FIG. 7 illustrates a simplified representation of a hook assembly in an open position according to an embodiment of the present invention.

FIG. 8 illustrates an isometric front view of a hook assembly according to an embodiment of the present invention.

FIG. 9 illustrates an isometric cross-sectional view of a hook assembly through line 9-9 of FIG. 8 according to an embodiment of the present invention.

FIG. 10 illustrates an isometric view of a resilient overmolded joint sleeve according to an embodiment of the present invention.

FIG. 11 illustrates an isometric view of a user engaging the hook assembly into an open position according to an embodiment of the present invention.

FIG. 12 illustrates an isometric view of a hook assembly engaging a securing loop member according to an embodiment of the present invention.

FIG. 13 illustrates an isometric view of a hook assembly secured to a securing loop member according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

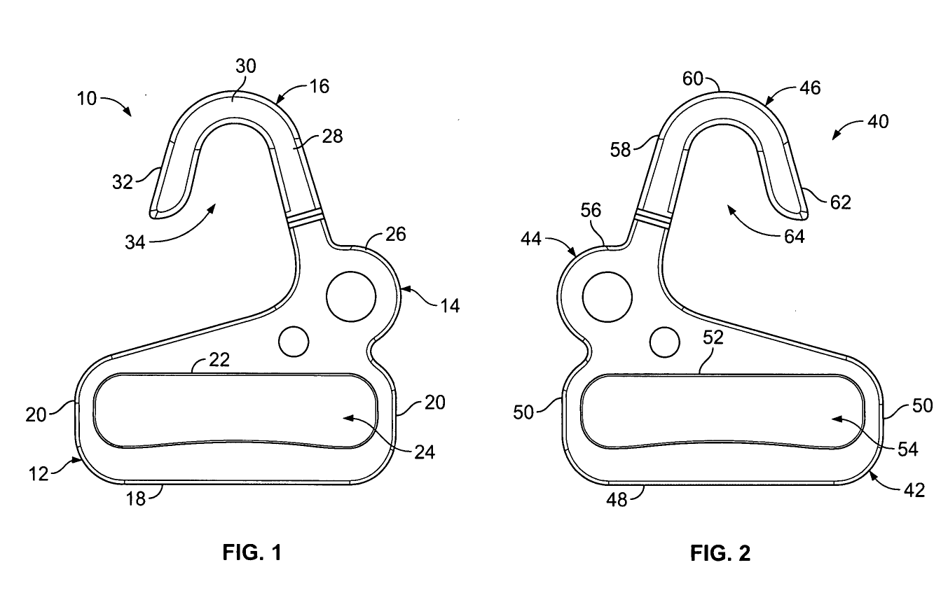

FIG. 1 illustrates a front perspective view of a hook member 10 according to an embodiment of the present invention. The hook member 10 may be a piece of stamped metal, and may include a strap-securing base 12 integrally formed with an intermediate engagement area or member 14. A hook 16 is integrally connected to, and extends from, the intermediate engagement area 14.

The strap-securing base 12 includes a lower crossbeam 18 integrally connected with lateral uprights 20, which are in turn integrally connected to an upper crossbeam 22. A strap-securing channel 24 is defined between the lower crossbeam 18, the lateral uprights 20, and the upper crossbeam 22. The strap-securing base 12 is configured to receive and retain a strap, sling, webbing, rope, or the like within the strap-securing channel 24.

The intermediate engagement area 14 integrally connects to the upper crossbeam 22 of the strap-securing base 12. The intermediate engagement area 14 is positioned over one of the lateral uprights 20, and may include an outwardly extending spur 26. The spur 26 provides greater surface area for a user to engage.

The hook 16 includes an extension beam 28 integrally formed with, and extending upwardly from, an upper portion of the spur 26. The extension beam 28 is integrally connected to a curved portion 30 that is, in turn, integrally connected to a distal tip 32. A securing cavity 34 is defined between the extension beam 28, the curved portion 30, and the distal tip 32.

FIG. 2 illustrates a front perspective view of a hook member 40 according to an embodiment of the present invention. The hook member 40 may be identical to the hook member 10 (shown in FIG. 1). That is, as shown in FIG. 2, the front view of the hook member 40 may merely be a rear view of the hook member 10.

Similar to the hook member 10, the hook member 40 may be a piece of stamped metal, and may include a strap-securing base 42 integrally formed with an intermediate engagement area 44. A hook 46 is integrally connected to, and extends from, the intermediate engagement area 44.

The strap-securing base 42 includes a lower crossbeam 48 integrally connected with lateral uprights 50, which are in turn integrally connected to an upper crossbeam 52. A strap-securing channel 54 is defined between the lower crossbeam 48, the lateral uprights 50, and the upper crossbeam 52. The strap-securing base 42 is configured to receive and retain a strap, sling, webbing, rope, or the like within the strap-securing channel 54.

The intermediate engagement area 44 integrally connects to the upper crossbeam 52 of the strap-securing base 42. The intermediate engagement area 44 is positioned over one of the lateral uprights 50, and includes an outwardly extending spur 56.

The hook 46 includes an extension beam 58 integrally formed with, and extending upwardly from, an upper portion of the spur 56. The extension beam 58 is integrally connected to a curved portion 60 that is, in turn, integrally connected to a distal tip 62. A securing cavity 64 is defined between the extension beam 58, the curved portion 60, and the distal tip 62.

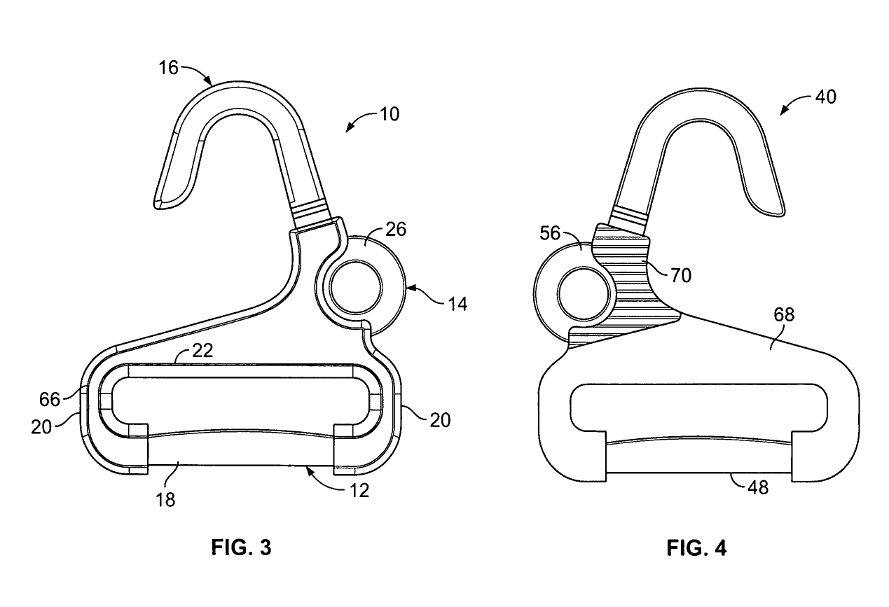

FIG. 3 illustrates a front perspective view of the hook member 10 with an overmolded cover 66. The overmolded cover 66 may extend over the lateral uprights 20 and the upper cross beam 22 of the strap-securing base 12, and over at least a portion of the intermediate engagement area 14. The overmolded cover 66 may also extend over the hook 16.

The overmolded cover 66 may be an infrared reflective polymer resin and/or a resilient elastomeric polymer that covers the metal portions identified above of the hook member 10. However, the overmolded cover 66 does not cover at least a portion of the lower crossbeam 18. Instead, the metal lower crossbeam 18 remains exposed.

FIG. 4 illustrates a front perspective view of the hook member 40 with an overmolded cover 68. The overmolded cover 68 covers similar metal portions of the hook member 40 as compared to the overmolded cover 66 (shown in FIG. 3) with respect to the hook member 10 (shown in FIG. 3). Similar to the hook member 10, at least a portion of the lower crossbeam 48 of the hook member 40 is not covered by the overmolded cover 68.

As shown in FIG. 4, a pressure pad 70 or engagement surface is formed on the overmolded cover 68 proximate the spur 56. While not shown in FIG. 3, the overmolded cover 66 also includes a pressure pad. Again, as shown in FIG. 4, the front view of the hook member 40 may be a rear view of the hook member 10.

The pressure pad 70 is configured to be engaged by a user. For example, a user may engage the pressure pad 70 with a thumb or finger.

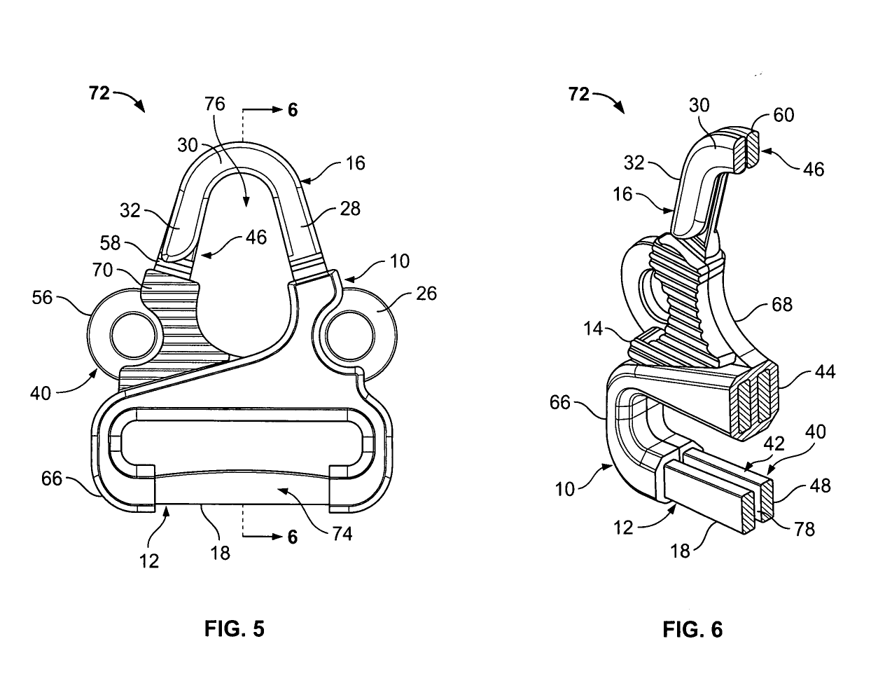

FIG. 5 illustrates a front perspective view of a hook assembly 72 with an exposed joint gap 74 according to an embodiment of the present invention. The joint gap 74 is defined by the exposed lower crossbeam 18 of the strap-securing base 12 of the hook member 10, and the exposed lower crossbeam 48 (hidden by the lower crossbeam 18) of the hook member 40.

As shown in FIG. 5, the hook member 10 abuts against the hook member 40. A securing area 76 is defined between the hook 16, and the intermediate engagement area 14 of the hook member 10, and the opposed hook 46 and the intermediate engagement area 44 of the hook 40. The pressure pad 70 of the hook member 40 is disposed on one side of the securing area 76, while the pressure pad of the hook member 10 (hidden from view in FIG. 5)) is disposed on the other side of the securing area 76. Further, the pressure pad of the hook member 10 faces the opposite direction as the pressure pad 70 the hook member 40.

The distal tip 32 of the hook 16 overlays the extension beam 58 of the hook 46. Further, the extension beam 28 of the hook 16 overlays the distal tip 62 (hidden from view in FIG. 5) of the hook 46.

FIG. 6 illustrates an isometric cross-sectional view of the hook assembly 72 through line 6-6 of FIG. 5. The overmolded intermediate engagement area 14 of the hook member 10 is directly biased against the overmolded intermediate engagement area 44 of the hook member 40. Similarly, the curved portion 30 of the hook 16 abuts against the curved portion 60 of the hook 46. A gap 78 may be formed between the exposed lower crossbeam 18 of the strap-securing base 12, and the exposed lower cross beam 48 of the strap-securing base 42.

Referring to FIGS. 5 and 6, when a user exerts a force into the pressure pad 70 of the hook member 40, and an oppositely-directed force into the pressure pad (hidden from view in FIGS. 5 and 6) of the hook member 10, the hook members 10 and 40 pivot about one another at the interface of the overmolded intermediate engagement areas 14 and 44. Consequently, the hooks 16 and 46 separate from one another, as do the strap-securing bases 12 and 42.

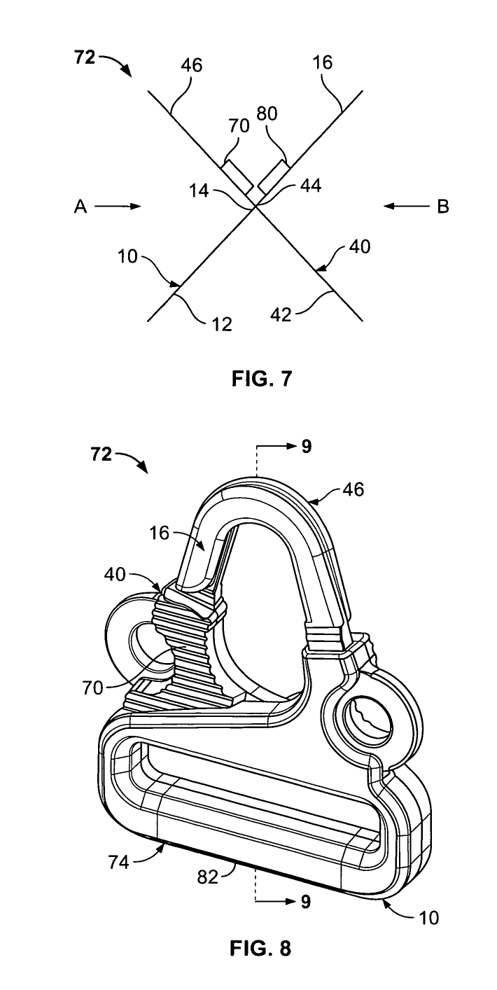

FIG. 7 illustrates a simplified representation of the hook assembly 72 in an open position. When a force is exerted into the pressure pad 80 of the hook member 10 in the direction of A, while an opposite force is exerted into the pressure pad 70 of the hook member 40 in the direction of B, the hook members 10 and 40 pivot relative to one another about the biased intermediate engagement areas 14 and 44. Consequently, the hook 16 moves away from the hook 46 in the direction of arrow A, while the hook 46 simultaneously moves away from the hook 16 in the direction of arrow B. During this movement, the strap-securing base 12 moves away from the strap-securing base 42 in the direction of arrow B, while the strap-securing base 42 simultaneously moves away from the strap-securing base 12 in the direction of arrow A.

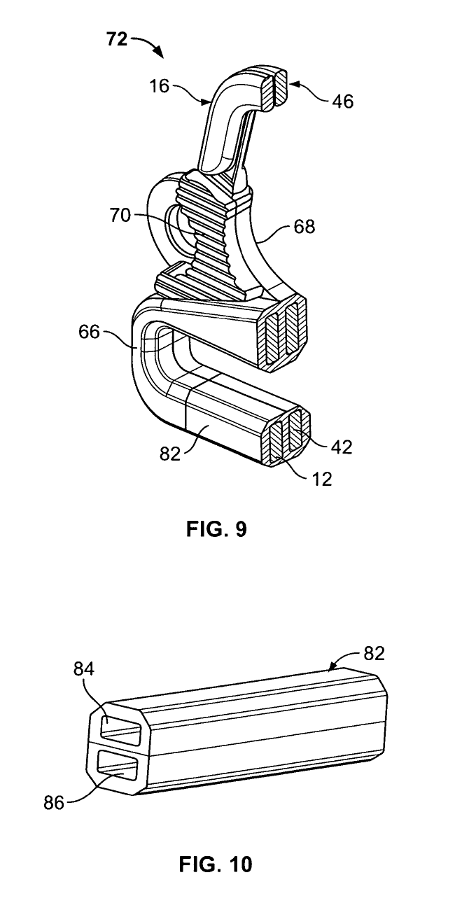

FIG. 8 illustrates an isometric front view of a hook assembly 72 according to an embodiment of the present invention. FIG. 9 illustrates an isometric cross-sectional view of the hook assembly 72 through line 8-8 of FIG. 7.

Referring to FIGS. 5-9, after the hook member 10 is aligned with respect to the hook member 40 as shown in FIG. 5, the hook assembly 72 is placed into a mold. A flexible polymer is injected into the mold around the joint gap 74 (i.e., the exposed lower crossbeam 18 and the exposed lower crossbeam 48). The injected flexible polymer hardens and forms a flexible overmolded joint sleeve 82 that covers the lower cross beam 18 and the lower cross beam 48. Because the overmolded joint sleeve 82 is resilient and flexible, the overmolded joint sleeve 82 allows the strap-securing bases 12 and 42 to separate from one another, as discussed above. However, after a user disengages the pressure pads, the resilient overmolded joint sleeve 82 squeezes the securing bases 12 and 42 back toward one another. That is, the resilient overmolded joint sleeve 82 exerts a constant inwardly directed force into the lower crossbeams 18 and 48. A user may overcome this force by engaging the pressure pads 70 and 80, as indicated above. When force is exerted into the pressure pads 70 and 80, the hook 16 separates from the hook 46, while the strap-securing base 12 separates from the strap-securing base 42. Once force is no longer exerted into the pressure pads 70 and 80, the resilient overmolded joint sleeve 82 squeezes the lower crossbeams 18 and 48 toward one another. Consequently, the hook 16 is urged back toward the hook 46.

FIG. 10 illustrates an isometric view of the resilient overmolded joint sleeve 82. The overmolded joint sleeve 82 may be formed of a flexible polymer, such as an elastomeric material. The overmolded joint sleeve 82 includes two channels 84 and 86 formed around the lower crossbeams 18 and 48 during the injection molding process.

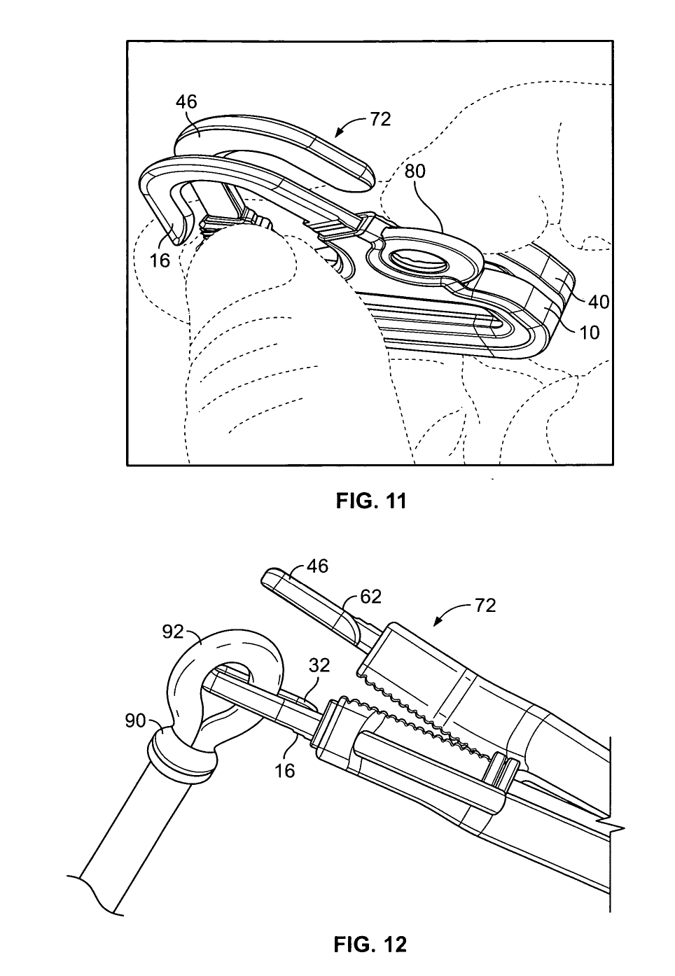

FIG. 11 illustrates an isometric view of a user engaging the hook assembly 72 into an open position according to an embodiment of the present invention. As discussed above, exerting force into the opposed pressure pads (only pressure pad 80 shown in FIG. 11) spreads the hooks 16 and 46 away from each other. Thus, a securing loop may be inserted over the hooks 16 and 46.

FIG. 12 illustrates an isometric view of the hook assembly 72 engaging a securing loop member 90 according to an embodiment of the present invention. The securing loop member 90 may be attached to a device, such as a weapon, while the hook assembly 72 may be secured to a strap. The securing loop member 90 includes a loop or ring 92. The loop 92 is inserted between the opened hooks 16 and 46 such that the distal tip 32 is inserted through the loop 92 and the distal tip 62 is also inserted through the loop 92. Once the loop 92 is positioned around both the hooks 16 and 46, a user disengages the pressure pads.

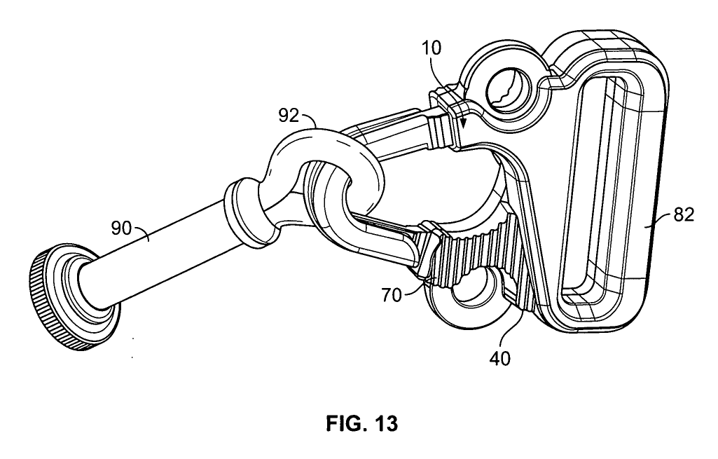

FIG. 13 illustrates an isometric view of the hook assembly 72 secured to the securing loop member 90 according to an embodiment of the present invention. Once a user disengages the pressure pads 70 and 80 (only pressure pad 70 shown in FIG. 13), the resilient overmolded joint sleeve 82 squeezes the hook member 10 back toward the hook member 40 in a closed position, as discussed above, thereby trapping the loop 92 over the hooks 16 and 46. Thus, the securing loop member 92 may be secured to the hook assembly 72.

Thus, embodiments of the present invention provide a durable and reliable hook assembly. Unlike prior hook devices, the embodiments discussed above do not include a fragile gate. Further, because the hook assembly includes metal hook members covered by overmolded plastic or another such polymer, the hook assembly is stronger than a unitary plastic hook. Further, because the hook assembly includes the plastic or polymer overmold, hook assembly is not susceptible to metal-to-metal banging or rattling. Additionally, the overmolded cover minimizes the infrared signature of the covered metal hook members of the hook assembly.

It is to be understood that terms such as top, bottom, above, below, lower, upper, lateral, and the like are relative terms. While these terms have been used to describe embodiments of the invention, such terms are merely used with respect to the drawings. That is, the orientations described may be inverted or different depending on the position of the hook assemblies shown and described.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A hook assembly configured to securely connect a strap to a device comprising:
first and second hook members, said first hook member being configured to pivot with respect to said second hook member into an open position;
first and second covers encasing at least portions of said first and second hook members, respectively; and
a resilient sleeve securing said first hook member to said second hook member, said resilient sleeve exerting a constant force into said first and second hook members to maintain said first and second hook members in a closed position.

2. The hook assembly of claim 1, wherein said first hook member comprises a first strap-securing base integrally connected to a first intermediate engagement area, which is in turn integrally connected a first hook, and wherein said second hook member comprises a second strap-securing base integrally connected to a second intermediate engagement area, which is in turn integrally connected to a second hook.

3. The hook assembly of claim 2, wherein said resilient sleeve is overmolded around at least portions of said first and second strap-securing bases.

4. The hook assembly of claim 2, wherein at least a portion of said first intermediate engagement area is pivotally biased into at least a portion of said second intermediate engagement area at a pivoting interface, wherein said first hook member is configured to pivot with respect to said second hook member about said pivoting interface so that said first hook is separated from said second hook.

5. The hook assembly of claim 1, wherein at least one of said first and second hook members is formed of metal.

6. The hook assembly of claim 1, wherein at least one of said first and second covers are formed of at least one of an overmolded infrared reflective polymer resin and a resilient elastomeric polymer.

7. The hook assembly of claim 1, wherein at least one of said first and second hook members comprises a strap-securing channel configured to receive and retain the strap.

8. The hook assembly of claim 1, wherein said first and second hook members are configured to removably secure to a loop member of the device.

9. The hook assembly of claim 1, wherein at least one of said first and second covers comprises an engagement surface configured to be engaged to pivot said first hook member into the open position with respect to said second hook member.

10. A hook assembly configured to securely connect a strap to a device comprising:
a first hook member comprising a first strap-securing base integrally formed with a first intermediate engagement member, which is in turn integrally formed with a first hook;
a second hook member comprising a second strap-securing base integrally formed with a second intermediate engagement member, which is in turn integrally formed with a second hook, at least a portion of said first intermediate engagement member being pivotally biased into at least a portion of said second intermediate engagement member at a pivoting interface, said first hook member being configured to pivot into an open position with respect to said second member about said pivoting interface;
a first cover encasing a least a portion of said first hook member;
a second cover encasing at least a portion of said second hook member; and
a resilient sleeve securing at least a portion of said first strap-securing base to at least a portion of said second strap-securing base, thereby securing said first hook member to said second hook member, said resilient sleeve acting to squeeze said first and second hook members together in a closed position by exerting a constant inwardly-directed force into said at least a portion of said first strap-securing base and said at least a portion of said second strap-securing base.

11. The hook assembly of claim 10, wherein said resilient sleeve is overmolded around at least portions of said first and second strap-securing bases.

12. The hook assembly of claim 10, wherein at least one of said first and second hook members is formed of metal.

13. The hook assembly of claim 10, wherein said first and second covers are formed of at least one of an overmolded infrared reflective polymer resin and a resilient elastomeric polymer.

14. The hook assembly of claim 10, wherein at least one of said first and second hook members comprises a strap-securing channel configured to receive and retain the strap.

15. The hook assembly of claim 10, wherein said first and second hook members are configured to removably secure to a loop member of the device.

16. The hook assembly of claim 10, wherein at least one of said first and second covers comprises an engagement surface configured to be engaged to pivot said first hook member into the open position with respect to said second hook member.

17. A hook assembly configured to securely connect a strap to a device comprising:
a metal first hook member comprising a first strap-securing base integrally formed with a first intermediate engagement member, which is in turn integrally formed with a first hook;
a metal second hook member comprising a second strap-securing base integrally formed with a second intermediate engagement member, which is in turn integrally formed with a second hook, at least a portion of said first intermediate engagement member being pivotally biased into at least a portion of said second intermediate engagement member at a pivoting interface, said first hook member being configured to pivot into an open position with respect to said second member about said pivoting interface;
a first cover encasing a least a portion of said first hook member, said first cover being formed of an infrared reflective material;
a second cover encasing at least a portion of said second hook member, said second cover also being formed of said infrared reflective material; and
a resilient sleeve overmolded around at least portions of said first and second strap-securing bases, thereby securing said first hook member to said second hook member, said resilient sleeve acting to squeeze said first and second hook members together in a closed position by exerting a constant inwardly-directed force into said at least a portion of said first strap-securing base and said at least a portion of said second strap-securing base.

18. The hook assembly of claim 17, wherein said infrared reflective material comprises at least one of a polymer resin and a resilient elastomeric polymer.

19. The hook assembly of claim 17, wherein at least one of said first and second hook members comprises a strap-securing channel configured to receive and retain the strap.

20. The hook assembly of claim 17, wherein at least one of said first and second covers comprises an engagement surface configured to be engaged to pivot said first hook member into the open position with respect to said second hook member.
